(19) United States
(12) Patent Application Publication
(10) Pub. No.: US 2012/0050449 A1
(43) Pub. Date: Mar. 1, 2012

(54) OPTICAL DEVICE, SURFACE-EMITTING LASER HAVING SUCH AN OPTICAL DEVICE, ELECTROPHOTOGRAPHIC APPARATUS HAVING THE SURFACE-EMITTING LASER AS EXPOSURE LIGHT SOURCE

(75) Inventor: Hideo Iwase, Kawasaki-shi (JP)

(73) Assignee: CANON KABUSHIKI KAISHA, Tokyo (JP)

(21) Appl. No.: 13/209,684

(22) Filed: Aug. 15, 2011

(30) Foreign Application Priority Data
Aug. 26, 2010 (JP) 2010-189178

(51) Int. Cl. B41J 2/435; G02B 5/30; G02B 27/28

(52) U.S. Cl. 347/224; 359/489.08; 359/489.07

(57) ABSTRACT

An optical device comprising a region divided into a first division plane running in parallel with a direction of an incident vector of a laser beam entering an incidence place for the laser beam and a second division plane running in parallel with the direction of the incident vector and normal to the first division plane, wherein: provides the laser beam with phase rotation angles differentiated by π between the regions divided by the first division plane when the laser beam travels in the direction of the incident vector and is linearly polarized in a direction parallel to the first division plane; and also provides the laser beam with phase rotation angles differentiated by π between the regions divided by the second division plane when the laser beam travels in the direction of the incident vector and is linearly polarized in a direction parallel to the second division plane.

### BACKGROUND OF THE INVENTION

1. Field of the Invention

The present invention relates to an optical device, to a surface-emitting laser having such an optical device and also to an electrophotographic apparatus having such a surface-emitting laser as an exposure light source. More particularly, the present invention relates to a surface-emitting laser that can make a focused spot of a laser beam having a single-peaked profile and be used as an exposure light source for an electrophotographic apparatus.

2. Description of the Related Art

In recent years, intensive research efforts have been paid to surface-emitting lasers in which light is emitted in a direction perpendicular to the surface of a substrate.

A surface-emitting laser can achieve single mode operations with ease and the divergence-angle of the laser beam emitted from such a laser is narrow compared with an edge-emitting laser. Also, a two-dimensional laser array can be formed with ease by using surface-emitting lasers.

For these reasons, researches have been and being made to use surface-emitting lasers as exposure light sources for electrophotographic apparatus and optical memory devices.

When surface-emitting semiconductor lasers are used as exposure light sources for electrophotographic apparatus or optical memory devices, the laser beam emitted from the lasers is focused onto the surface of a photosensitive member through a condensing lens. Therefore, generally smaller focused spot of the laser beam improves the resolution of exposure.

Japanese Patent Application Laid-Open No. 2007-258260 describes a photonic crystal surface-emitting laser that can emit a laser beam having an annular cross section and a polarization in a radial direction so as to reduce the diameter of the focused spot.

FIG. 19A of the accompanying drawings schematically illustrates the structure of a photonic crystal surface-emitting laser and the direction of polarization of the laser beam described in Japanese Patent Application Laid-Open No. 2007-258260.

In FIG. 19A, 39 denotes a substrate and 40 denotes an output plane, while 41 and 42 respectively denote a circumferentially polarized annular laser beam and a π/2 wave plate and 43 and 44 respectively denote phase advancing axes and a radially polarized annular laser beam.

The photonic crystal surface-emitting laser includes two ½ wave plates 42 laid stacked on the output plane 40 and the phase advancing axes 43 of the two 1/2 wave plates 42 form an angle of 45°.

“Finite-Difference Time-Domain Simulation of Two-Dimensional Photonic Crystal Surface-Emitting Laser Having a Square-Lattice Slab Structure”, IEICE Transactions on Electronics, vol. E87-C, No. 3, March 2004, pp. 386-392 describes matters relating to the cross-sectional intensity distribution and the direction of polarization of a laser beam emitted from a photonic crystal surface-emitting laser having no wave plate.

Namely, according to “Finite-Difference Time-Domain Simulation of Two-Dimensional Photonic Crystal Surface-Emitting Laser Having a Square-Lattice Slab Structure”, IEICE Transactions on Electronics, vol. E87-C, No. 3, March 2004, pp. 386-392, the laser beam 41 emitted from the output plane 40 of the substrate surface shows an annular cross-sectional intensity distribution. The polarized beam is so directed as to circulate along the circumference of the laser beam (such a laser beam is referred to as circumferentially polarized annular laser beam hereinafter). The above-cited document describes circumferentially polarized annular laser beams.

With a surface-emitting laser according to Japanese Patent Application Laid-Open No. 2007-258260, as a circumferentially polarized annular laser beam passes through two ½ wave plates 42 that are inclined at 45° relative to each other, its polarization is shifted into a radial direction, i.e., the direction from the center of the laser beam toward the outside thereof (to be referred to as radially polarized annular laser beam hereinafter).

R. Dorn et al., “Sharper Focus for a radially polarized Light Beam”; Physical Review Letters, vol. 91, No. 23, pp. 233901-1 to 233901-4 describes a mechanism that reduces a spot diameter beyond a diffraction limit when a radially polarized annular laser beam is focused through condensing lens. The expression of “focusing limit” as used therein refers to a theoretical minimum value of a focused spot that is determined with the wavelength of a laser beam and the aperture of a condensing lens when a linearly polarized plane wave passes through a condensing lens. FIG. 19B is a schematic illustration of mechanism of focusing a radially polarized annular laser beam beyond a diffraction limit in a conventional art.

In FIG. 19B, 45, 46, and 47 respectively denote electric field vectors, a cross-sectional intensity distribution, and electric field vectors. Numerals 48 and respectively denote the parallel components of the electric field vectors, and the orthogonal components of electric field vectors. Numerals 50 and 51 respectively denote a condensing lens and an optical axis and 57 denotes a spot center.

Additionally, in FIG. 19B, 61 denotes the relationship between the cross-sectional intensity distribution 46 of the radially polarized annular laser beam and the electric field vectors 45. Numeral 62 denotes the electric field vectors of the laser beam before and after a laser beam passes through the condensing lens 50.

The numerical aperture of the condensing lens is about 0.8 and the electric field vectors 47 directed to the center of the radially polarized annular laser beam are inclined after the laser beam passes through the lens. At this time, the components 48 of the electric field vectors lying parallel to the optical axis (the parallel components of the electric field) are about 1.7 times greater than the components 49 orthogonal to the optical axis (the orthogonal components of the electric field).

After the laser beam passes through the condensing lens 50, the parallel components 48 of the electric field vectors do not change their direction, whereas the orthogonal components 49 of the electric field vectors face the opposite directions. Thus, at the focal point of the lens, the parallel components of the electric field that bear much of the energy of the electric field are interfere with each other in the same phase to produce a sharp peak of electric field intensity at the center 57 of the focused spot of light.

However, a photonic crystal surface-emitting laser as described in Japanese Patent Application Laid-Open No. 2007-258260 entails a difficulty in reducing the diameter of a focused spot of light by using a condensing lens having a numerical aperture not greater than 1/√2≈0.71.

FIG. 20A illustrates electric field vectors of a radially polarized annular laser beam after passing through a condensing lens with a numerical aperture of about 0.2.

In FIG. 20A, 63 denotes the electric field vector distribution in a laser beam cross section of a radially polarized annular laser beam and 64 denotes the inclinations of electric field vectors of the laser beam after passing through a condensing lens with a numerical aperture of 0.2. At 64, the laser beam is inclined at about 11° relative to the optical axis 51 after passing through the condensing lens 50.

Unlike the instance illustrated in FIG. 19B where a laser beam is focused by a condensing lens having a high numerical aperture, the orthogonal components 49 of the electric field vectors become greater than the parallel components 48 of the electric field vectors in FIG. 20A. Therefore, at the center 57 of the focused spot of light, the orthogonal components that bear most of the energy of the electric field are interfere with each other in the opposite phase to weaken each other.

On the other hand, a position site can be found away from the center of the focused spot of light, at which the orthogonal components of the electric field vectors interfere with each other to strengthen.

As a result, a focused spot of a radially polarized annular laser beam that is focused by a condensing lens with a numerical aperture of 0.2 does not show a single-peaked profile having the peak at the center of the spot.

Generally, when a laser beam is focused by a condensing lens with a numerical aperture of 1/√2 as illustrated in FIG. 20B, the electric field vectors 47 of a radially polarized annular laser beam are inclined at about 45° relative to the optical axis 51 after passing through a condensing lens, which makes the magnitudes of the parallel components 48 of the electric field vectors equal to those of the orthogonal components 49.

Numeral 65 denotes distribution of the electric field vectors in a laser beam cross section of a radially polarized annular laser beam and 66 denotes the inclinations of electric field vectors of the laser beam after passing through a condensing lens with a numerical aperture of 1/√2 to 0.71.

As clearly seen from FIGS. 19A, 19B, 20A and 20B, the numerical aperture of the condensing lens needs to be not greater than 1/√2 to make the magnitudes of the orthogonal components of the electric field vector greater than those of the parallel components, whereas the numerical aperture of the condensing lens needs to be greater than 1/√2 to make the amplitudes of the parallel components of the electric field vectors greater than those of the orthogonal components.

Additionally, as illustrated in FIG. 19B, the magnitudes of the parallel components of the electric field vectors need to be at least greater than the orthogonal components to reduce a size of a focused spot of a radially polarized annular laser beam.

Thus, when a radially polarized annular laser beam is focused by a condensing lens with a numerical aperture of less than 1/√2, an effect of reducing the focused spot of light can hardly be obtained.

Generally, in optical recording apparatus and electrophotographic apparatus a high-speed laser-beam scanning on the surface of a photosensitive member requires a deep focal depth that can compensate variations of the optical path length of the laser beam during the scanning. Hence, the use of a condensing lens with a high numerical aperture satisfying a requirement of numerical aperture>1/√2 to 0.71 is unsuitable.

Therefore, a focused spot of a circumferentially polarized annular laser beam having a single-peaked profile by means of the components described in Japanese Patent Application Laid-Open No. 2007-258260 is not suitable for optical recording apparatus and electrophotographic apparatus.

### SUMMARY OF THE INVENTION

An object of the present invention is to provide an optical device that can make a focused spot of a circumferentially polarized annular laser beam show a single-peaked profile by means of phase-controlling a circumferentially polarized annular laser beam when the laser beam is focused by a condensing lens with a numerical aperture of not greater than 1/√2, and a surface-emitting laser having such an optical device.

Another object of the present invention is to provide an electrophotographic apparatus having such a surface-emitting laser as an exposure light source.

According to the present invention, an optical device for making the focused spot of the laser beam show a single-peaked profile by means of phase-controlling a circumferentially polarized annular laser beam includes a region divided into a first division plane running in parallel with a direction of an incident vector of a laser beam entering an incidence place of the laser beam and a second division plane running in parallel with the direction of the incident vector and normal to the first division plane, wherein the laser beam is provided with phase rotation angles differentiated by π between the regions divided by the first division plane when the laser beam travels in the direction of the incident vector and is linearly polarized in a direction parallel to the first division plane; and the laser beam is also provided with phase rotation angles differentiated by π between the regions divided by the second division plane when the laser beam travels in the direction of the incident vector and is linearly polarized in a direction parallel to the second division plane.

Thus, according to the present invention, an optical device that can make a focused spot of a circumferentially polarized annular laser beam show a single-peaked profile when the laser beam is focused by a condensing lens with a numerical aperture of not greater than 1/√2 and a surface-emitting laser having such an optical device can be realized.

Further features of the present invention will become apparent from the following description of exemplary embodiments with reference to the attached drawings.

### BRIEF DESCRIPTION OF THE DRAWINGS

FIG. 1 is a schematic perspective view illustrating the configuration of the optical device of Example 1 of the present invention.

FIG. 2 is a schematic illustration of the matrix showing the refractive indexes of the wave plates 1, 2 and the optical plates 3, 4 in the first through fourth regions when a laser beam travelling in the direction of the incident vector enters the optical device of Example 1 illustrated in FIG. 1.

FIG. 3 is a schematic illustration of the matrix showing the phase rotation angles of the laser beam after passing through the first region through the fourth region of the optical device of Example 1 illustrated in FIG. 1.

FIG. 4 is a schematic illustration of the cross-sectional intensity distribution and the electric field vectors of a circumferentially polarized annular laser beam entering the optical device of Example 1 illustrated in FIG. 1.

FIG. 5A is a schematic illustration of the linearly polarized component running in parallel with the x-axis of the electric field vectors of a circumferentially polarized annular laser beam in Example 1 of the present invention.

FIG. 5B is a schematic illustration of the linearly polarized component running in parallel with the y-axis of the electric field vectors of a circumferentially polarized annular laser beam in Example 1 of the present invention.

FIG. 6 is a schematic illustration of the cross-sectional intensity distribution and the electric field vectors of a circumferentially polarized annular laser beam after passing through the optical device of Example 1 of the present invention.

FIG. 7A is a schematic illustration of the linearly polarized component of a circumferentially polarized annular laser beam running in parallel with the x-axis of the electric field vectors after passing through the optical device of Example 1 of the present invention.

FIG. 7B is a schematic illustration of the linearly polarized component of a circumferentially polarized annular laser beam running in parallel with the y-axis of the electric field vectors after passing through the optical device in Example 1 of the present invention.

FIG. 8 is a schematic illustration of a focused spot of a circumferentially polarized annular laser beam after passing through the optical device of Example 1 of the present invention.

FIG. 9A is a schematic illustration of the cross-sectional intensity distribution and the electric field vectors of a circumferentially polarized annular laser beam in Comparative Example.

FIG. 9B is a schematic illustration of a focused spot of a circumferentially polarized annular laser beam in Comparative Example.

FIG. 10A is a schematic illustration of the cross-sectional intensity distribution and the electric field vectors of a radially polarized annular laser beam in Comparative Example.

FIG. 10B is a schematic illustration of a focused spot of a radially polarized annular laser beam in Comparative Example.

FIG. 11 is a schematic perspective view illustrating the configuration of the optical device of Example 2 of the present invention.

FIG. 12A is a schematic illustration of the matrix showing the refractive index of the first phase control plate when a laser beam linearly polarized in directions parallel to the x-axis and the y-axis enters the optical device of Example 2 of the present invention.

FIG. 12B is a schematic illustration of the matrix showing the refractive index of the second phase control plate when a laser beam linearly polarized in directions parallel to the x-axis and the y-axis enters the optical device of Example 2 of the present invention.

FIG. 13A is a schematic illustration of the phase rotation angle when a laser beam passes through the first phase control plate of the optical device of Example 2 of the present invention.

FIG. 13B is a schematic illustration of the phase rotation angle when a laser beam passes through the second phase control plate of the optical device of Example 2 of the present invention.

FIG. 14 is a schematic illustration of the cross-sectional intensity distribution, the electric field vectors and the linearly polarized components of the electric field vectors travelling in parallel with the x-axis and the y-axis of an annular laser beam after passing through the first and second phase control plates of the optical device of Example 2.

FIG. 15 is a schematic illustration of the focusing pattern of a circumferentially polarized annular laser beam after passing through the optical device illustrated in FIGS. 13A and 13B in Example 2 of the present invention.

FIG. 16 is a schematic perspective view illustrating the configuration of the photonic crystal surface-emitting laser in Example 3 of the present invention.

FIG. 17A is a schematic illustration of the results of calculations of the cross-sectional intensity distribution and the electric field vectors of a circumferentially polarized annular laser beam emitted from a photonic crystal surface-emitting laser as described in R. Dorn et al., “Sharper Focus for a radially polarized Light Beam”; Physical Review Letters, vol. 91, No. 23, pp. 233901-1 to 233901-4.

FIG. 17B is a schematic plan view of the photonic crystal surface-emitting laser having a photonic crystal structure in Example 3 of the present invention.

FIG. 18 is a schematic perspective view of the electrophotographic apparatus in Example 4 of the present invention.

FIG. 19A is a schematic perspective view illustrating the configuration of a conventional art photonic crystal surface-emitting laser.

FIG. 19B is a schematic illustration of a mechanism of focusing a radially polarized annular laser beam beyond a diffraction limit in a conventional art.

FIG. 20A is a schematic illustration of a problem of the conventional art.

FIG. 20B is a schematic illustration of another problem of the conventional art.

### DESCRIPTION OF THE EMBODIMENTS

Now, modes for carrying out the present invention will be described below by way of examples.

### EXAMPLES

### Example 1

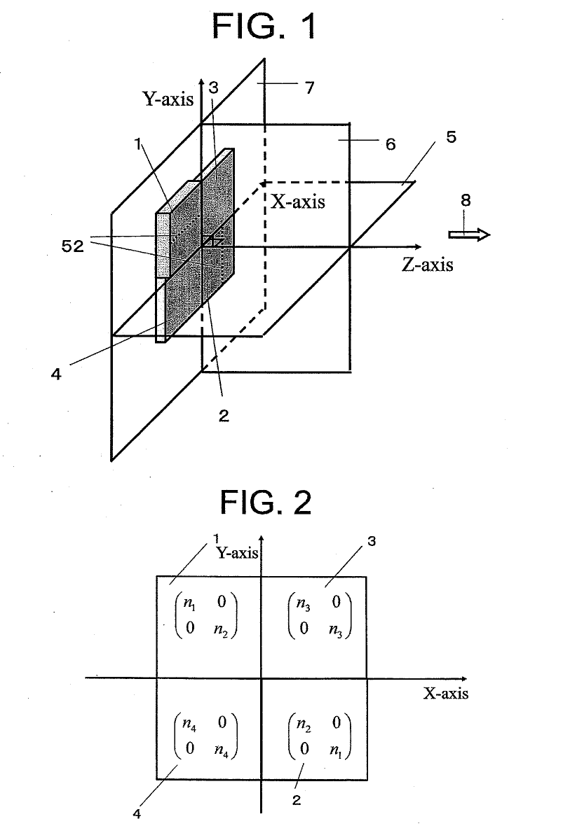

An optical device according to the present invention and having an exemplar configuration will be described below for Example 1 by referring to FIG. 1.

The optical device of this example has a configuration as described below.

The optical device has a plane 7 that is the incidence place where a laser beam enters and is divided into four regions including the first through fourth that are separated by plane 5 and plane 6 that are in parallel with the incident vector 8 of a laser beam and normal to each other (the plane 5 and the plane 6 will be referred to respectively as the first division plane and the second division plane hereinafter).

Wave plate 1 and wave plate 2 that are birefringent members are arranged respectively in the second region and in the fourth region, which are one of the two pairs of diagonally disposed regions.

On the other hand, optical plate 3 and optical plate 4 that are non-birefringent members are arranged respectively in the first region and in the third region, which are the other one of the two pairs of diagonally disposed regions.

The incident vector is a vector indicating the direction in which a laser beam enters the optical device of FIG. 1. In the following description, a laser beam entering the optical device is assumed to travel in parallel with the incident vector.

For the following description, the x-axis, the y-axis and the z-axis are defined as follows. The line of intersection of the plane 7, that a laser beam enters and the direction of the incident vector crosses orthogonally (to be referred to as incidence place hereinafter), and the above described first division plane is defined to be the x-axis.

Secondly, the line of intersection of the incidence place and the second division plane is defined as the y-axis.

Finally, the line of intersection of the first division plane and the second division plane is defined as the z-axis. Thus, the z-axis runs in parallel with the incident vector.

The wave plates 1, 2 operate as ½ wave plates for the wavelength λ of the laser beam and are so arranged that the phase advancing axis and the phase lagging axis of the wave plate 1 run respectively in parallel with the x-axis and the y-axis, while the phase advancing axis and the phase lagging axis of the wave plate 2 run respectively in parallel with the y-axis and the x-axis.

The optical plates 3, 4 are so designed as to provide a laser beam that is linearly polarized in the direction of the x-axis with a phase rotation angle that is equal to the one given to the laser beam when it passes through the wave plates 1, 2.

A matrix showing the refractive indexes of the wave plates 1, 2 and the optical plates 3, 4 in the first through fourth regions when a laser beam travelling in the direction of the incident vector enters the optical device of FIG. 1 will be described below.

The (1, 1) component of the matrix shows the refractive indexes when a laser beam linearly polarized in the direction of the x-axis enters the optical device, while the (2, 2) component of the matrix shows the refractive indexes when a laser beam linearly polarized in the direction of the y-axis enters the optical device.

The direction of polarization and linear polarization refers to the direction of the electric field vector.

The optical plates are made of a non-birefringent material and hence the diagonal components of refractive index are equal to each other. The x-axis in the second region and the y-axis in the fourth region are respectively the phase advancing axes 52 of the installed wave plates 1, 2. That is, the non-diagonal components of the matrix are nil and n1<n2.

Additionally, that the wave plates 1, 2 operate as ½ wave plates. That is, when the thickness of the wave plates 1, 2 is L, the relationship of π=L×(n2−n1)2π/λ is satisfied for the wavelength λ of the incident laser beam.

Furthermore, the thicknesses L3 and L4 of the optical plates 3, 4 in FIG. 1 are so determined as to satisfy the respective relationships of L3×n3+(L−L3)×1=L×n1 and L4×n4+(L−L4)×1=L×n2.

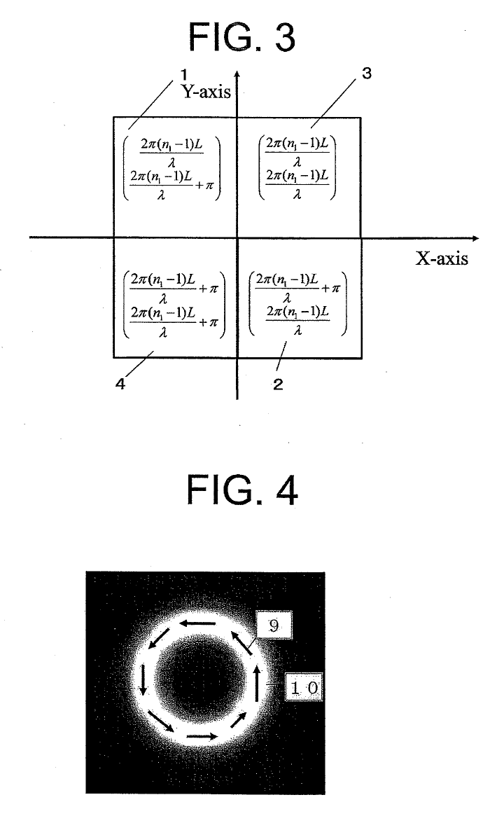

Now, the matrix expressing the phase rotation angles of laser beams that have passed through the first through fourth regions of the optical device of FIG. 1 will be described below by referring to FIG. 3.

A phase rotation angle is defined by an angle determined by subtracting the optical path length of a laser beam not passing through the optical device from the optical path length of the laser beam passing through the optical device and multiplying the difference by 2π/λ.

Thus, a phase rotation angle as defined above corresponds to the quantity expressing the phase shift of oscillations of an electromagnetic field due to passing through the optical device. When a phase rotation angle of π+m×2π (m being an integer) is given, the electric field vector is inverted after passing through the optical device relative to the electric field vector that is observed when not passing through the optical device.

In FIG. 3, the (1, 1) component of the matrix expresses the phase rotation angle when a laser beam linearly polarized in the direction of the x-axis passes through and the (2, 1) component of the matrix expresses the phase rotation angle when a laser beam linearly polarized in the direction of y-axis passes through.

The matrix of FIG. 3 shows that, when a laser beam linearly polarized in the direction of the x-axis enters the optical device, the phase rotation angle of the laser beam after passing through the third and fourth regions will be greater than the phase rotation angle of the laser beam after passing through the first and second regions by π.

Similarly, the matrix shows that, when a laser beam linearly polarized in the direction of the y-axis enters the optical device, the phase rotation angle of the laser beam after passing through the second and third regions will be greater than the phase rotation angle of the laser beam after passing through the first and fourth regions by π.

In other words, the matrix of FIG. 3 shows that, when a laser beam that travels in the direction of the incident vector and is linearly polarized in the direction parallel to the first division plane enters the optical device, the phase rotation angle given to the laser beam is differentiated by π between the regions divided by the first division plane.

Additionally, the matrix of FIG. 3 shows that, when a laser beam that travels in the direction of the incident vector and is linearly polarized in the direction parallel to the second division plane enters the optical device, the phase rotation angle given to the laser beam is differentiated by π between the regions divided by the second division plane.

In the following description, that the phase rotation angle is differentiated by π between the divided regions will be expressed as phase inversion.

FIG. 4 is a schematic illustration of the cross-sectional intensity distribution 10 and the electric field vectors 9 of a circumferentially polarized annular laser beam entering the optical device of FIG. 1.

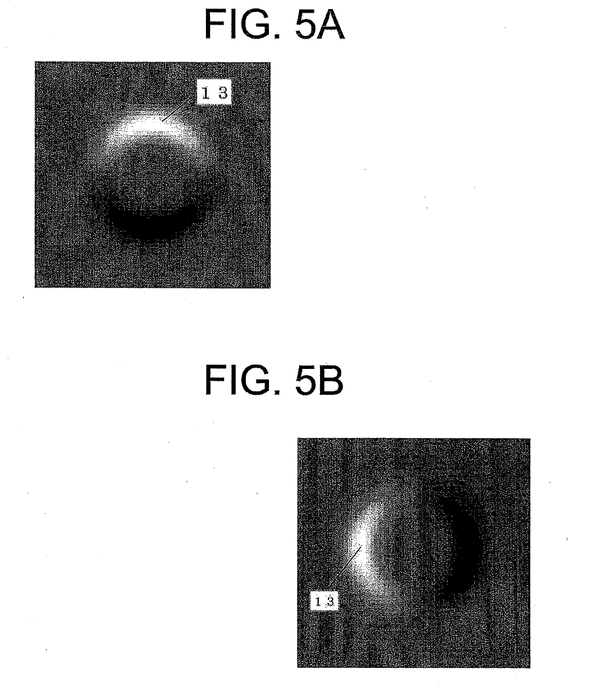

FIGS. 5A and 5B schematically illustrate the linearly polarized components 13 travelling in parallel with the x-axis and the y-axis of the electric field vectors of a circumferentially polarized annular laser beam.

Color inversion of the linearly polarized components 13 in FIGS. 5A and 5B indicates that the electric field vectors are directed oppositely in the different regions of color.

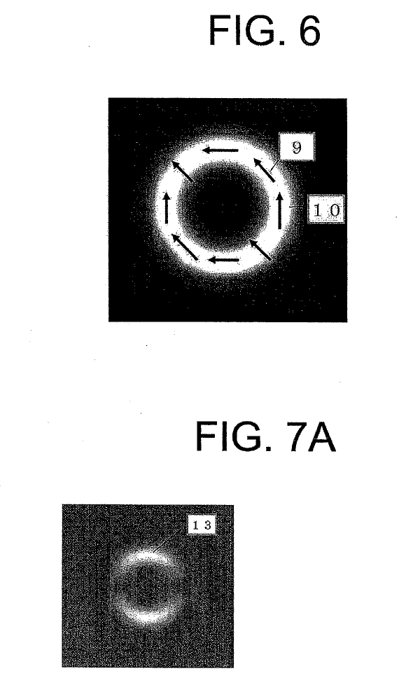

FIG. 6 is a schematic illustration of the cross-sectional intensity distribution 10 and the electric field vectors 9 after passing through the optical device of FIG. 1.

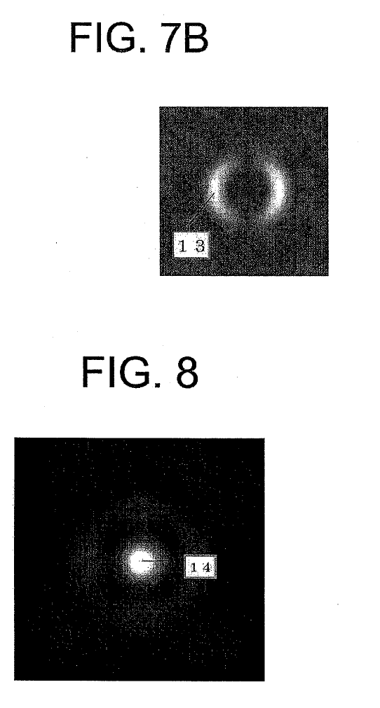

FIGS. 7A and 7B are schematic illustrations of the linearly polarized components running in parallel with the x-axis and the y-axis of the electric field vectors after passing through the optical device of FIG. 1.

As clearly seen from FIGS. 5A, 5B, 7A and 7B, the linearly polarized components of electric field vectors are provided with a phase rotation angle that is differentiated by π between the divided regions and the linearly polarized components of electric field vectors are made to face the same direction after passing through the optical device.

FIG. 8 is a schematic illustration of a focused spot of an annular laser beam showing polarization of FIG. 6 that is formed when focused by a condensing lens with a numerical aperture of 0.1. In FIG. 8, 14 denotes the center of the spot. The focused spot shows a single-peaked profile as a result of phase inversion.

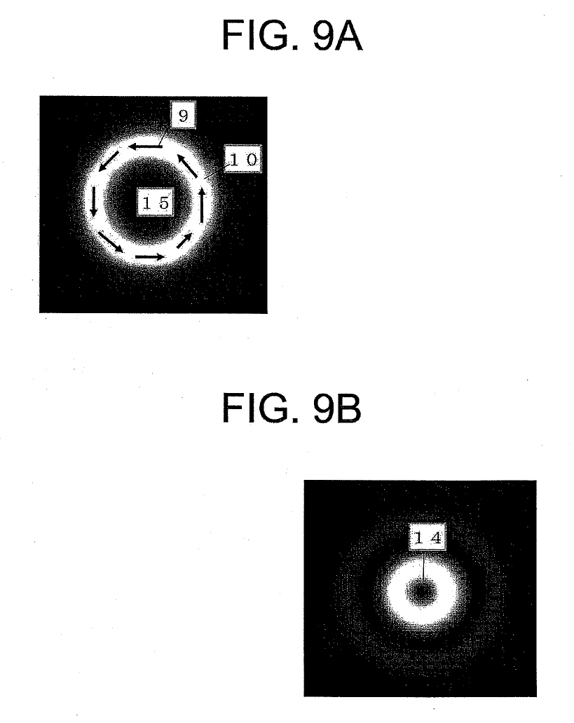

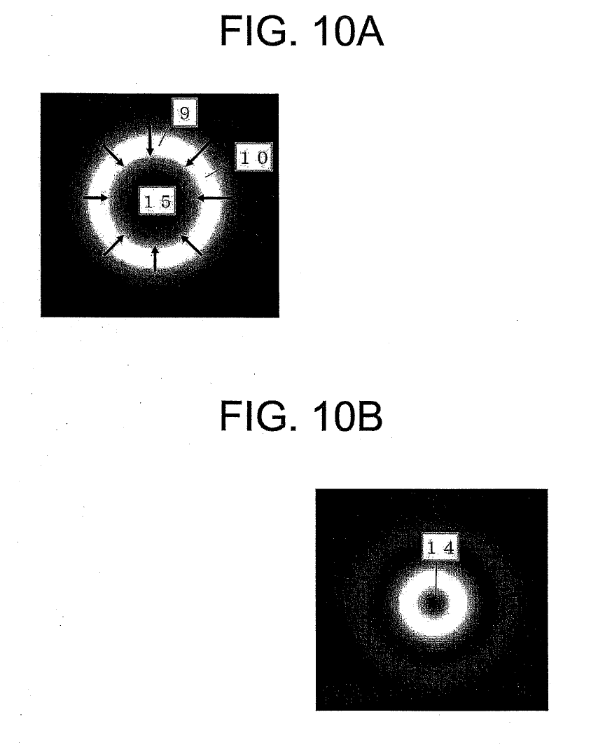

FIGS. 9A, 9B, 10A and 10B illustrate the cross-sectional intensity distributions 10, the electric field vectors 9 and the focusing patterns produced when focused by a lens with a numerical aperture of 0.1 of a circumferentially polarized annular laser beam and a radially polarized annular laser beam described in Japanese Patent Application Laid-Open No. 2007-258260 illustrated in Comparative Example. In the drawings, 14 denotes the spot center and 15 denotes the center of the laser beam.

In each case, since the electric field vectors facing each other across the center of the laser beam are directed oppositely, destructive interferences arise at the center 14 of the focused spot and the focusing pattern does not show a single-peaked profile, when focused by a lens with a low numerical aperture.

Generally, the transmission and the reflection on the surface of the optical member depend on the member.

The arrangement of the present invention utilizes interferences of electric field vectors positioned symmetrically relative to the center of an annular laser beam and fluctuations of intensity distribution due to passing through an optical device is desirably small.

For this reason, the surfaces of the wave plates 1, 2 and the optical plates 3, 4 of the optical device illustrated in FIG. 1 of this example are preferably coated with anti-reflection film, reflection film or absorption film that equalizes the transmittance factors of the first through fourth regions.

### Example 2

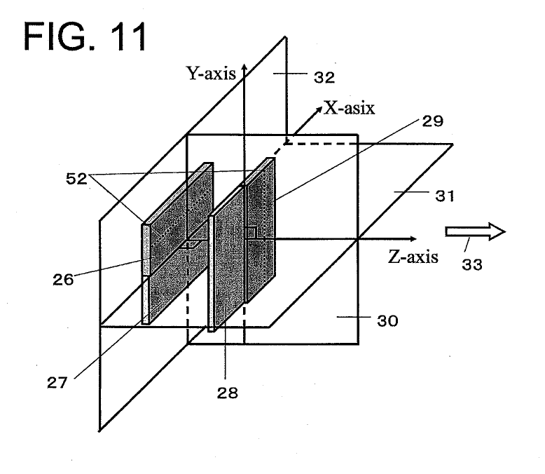

Now, an exemplar configuration of the optical device of Example 2 different from that of the optical device of Example 1 will be described below by referring to FIG. 11.

In FIGS. 11, 26 and 29 denote wave plates and 27 and 28 denote optical plates while 30 and 31 respectively denote the second division plane and the first division plane and 32 and 33 respectively denote the incidence place and the incident vector. The incident vector 33 is orthogonal relative to the incidence place 32.

The optical device of this example has a configuration as described below.

The optical device has the first division plane 31 and the second division plane 30 that are in parallel with the incident vector 33 of a laser beam and orthogonal relative to each other.

Additionally, the optical device of this example has the first and second phase control plates that are orthogonal relative to the incident vector 33 and parallel to the incidence place 32.

The first phase control plate is divided by the first division plane 31 that is parallel to the incident vector 33 and a ½ wave plate 26 and an optical plate 27 are arranged there. The second phase control plate is divided by the second division plane 30 that is parallel to the incident vector and orthogonal to the first division plane 31 and a ½ wave plate 29 and an optical plate 28 are arranged there. These optical plates 27, 28 are formed by respective transparent plates that are non-birefringent members as in the case of Example 1.

For the following description, the x-axis, the y-axis and the z-axis are defined as follows. The line of intersection of the plane 32, that a laser beam enters and the direction of the incident vector crosses orthogonally (to be referred to as incidence place hereinafter), and the above described first division plane is defined to be the x-axis.

Secondly, the line of intersection of the incidence place and the second division plane is defined as the y-axis.

Finally, the line of intersection of the first division plane and the second division plane is defined as the z-axis. Thus, the z-axis runs in parallel with the incident vector.

In FIG. 11, the directional arrangement of the wave plate 26 is so adjusted that its phase advancing axis and its phase lagging axis respectively run in parallel with the x-axis and the y-axis. Similarly, the directional arrangement of the wave plate 29 is so adjusted that its phase advancing axis and its phase lagging axis respectively run in parallel with the y-axis and the x-axis. Additionally, the optical plate 27 is so designed that a laser beam that is linearly polarized in a direction parallel to the second division plane is provided with a phase rotation angle equal to the one given to it when it passes through the wave plate 26. Likewise, the optical plate 28 is so designed that a laser beam that is linearly polarized in a direction parallel to the first division plane is provided with a phase rotation angle equal to the one given to it when it passes through the wave plate 29.

In the following description, a laser beam that enters the optical device of FIG. 11 is assumed to travel in a direction parallel to the incident vector.

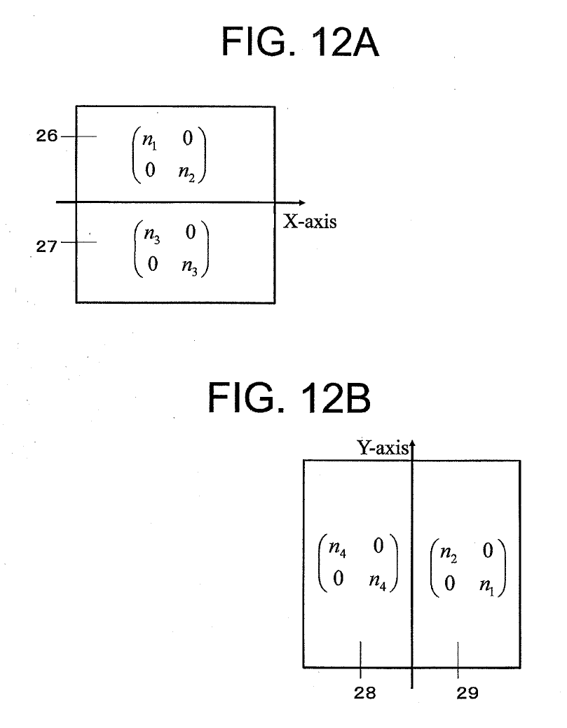

FIGS. 12A and 12B are schematic illustrations of the matrixes showing the refractive index of the first phase control plate and that of the second phase control plate when a laser beam linearly polarized in directions parallel to the x-axis and the y-axis enters the optical device.

The (1, 1) component of the matrix shows the refractive indexes when a linearly polarized laser beam enters in the direction of the x-axis, while the (2, 2) component of the matrix shows the refractive indexes when a linearly polarized laser beam enters in the direction of the y-axis.

Note here that the x-axis of the wave plate at the first phase control plate and the y-axis of the wave plate at the second phase control plate respectively operate as the phase advancing axes. That is, the non-diagonal components of the matrix are nil and n1<n2.

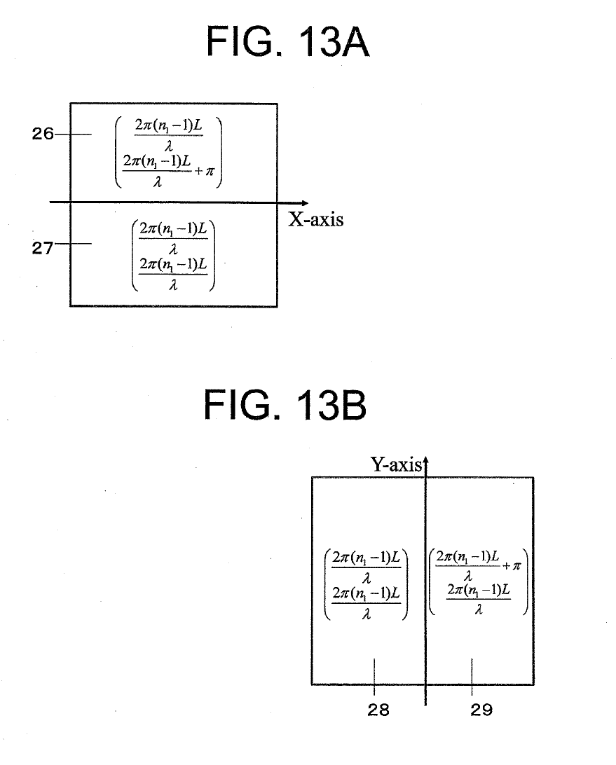

Additionally, in FIGS. 13A and 13B, the wave plates 1, 2 operate as ½ wave plates. That is, when the thickness of the wave plates 1, 2 is L, the relationship of π=L×(n2−n1)2π/λ holds true for the wavelength λ of the incident laser beam.

Furthermore, when the thickness of the wave plates is L, the thicknesses L3 and L4 of the optical plates 27, 28 are so determined as to satisfy the respective relationships of L3×n3+(L−L3)×1=L×n2 and L4×n4+(L−L4)×1=L×n2.

FIGS. 13A and 13B illustrate the phase rotation angles of a laser beam when the laser beam passes through the first and second phase control plates respectively.

The (1, 1) component of the matrix expresses the phase rotation angle when a laser beam linearly polarized in the direction of the x-axis passes through and the (2, 1) component of the matrix expresses the phase rotation angle when a laser beam linearly polarized in the direction of y-axis passes through.

The first and second phase control plates operate in a manner as described below. Firstly, when a laser beam that is linearly polarized in the direction of the x-axis passes, the optical plate 27 of the first phase control plate shows a phase rotation angle greater than that of the wave plate 26 by π so as to give rise to a phase inversion, whereas the second phase control plate does not give rise to any phase inversion.

In other words, after passing through the optical device, a laser beam that is linearly polarized in a direction parallel to the first division plane is provided with a phase rotation angle that is differentiated by π between the region divided by the division plane 31 running in parallel to the x-axis so as to give rise to a phase inversion.

Likewise, when a laser beam that is linearly polarized in the direction of the y-axis passes, the first phase control plate does not give rise to any phase inversion, while the optical plate 28 at the second phase control plate shows a phase rotation angle greater than that of the wave plate 29 by π so as to give rise to a phase inversion.

In short, after passing through the optical device, a laser beam that is linearly polarized in a direction parallel to the second division plane is provided with a phase rotation angle that is differentiated by π between the regions divided by the division plane 30 running in parallel with the y-axis so as to give rise to a phase inversion.

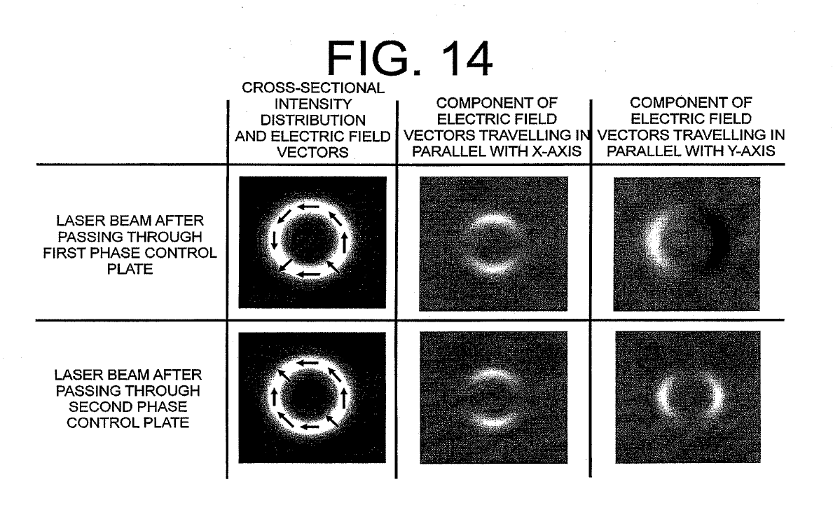

FIG. 14 is a schematic illustration of the cross-sectional intensity distribution, the electric field vectors and the linearly polarized components of the electric field vectors travelling in parallel with the x-axis and the y-axis of an annular laser beam after passing through the first and second phase control plates.

A laser beam that is linearly polarized in the direction of the x-axis is provided with a phase rotation angle that is differentiated by π between the regions divided by the related division plane when it passes through the first phase control plate and the linearly polarized components of the electric field vectors running in the direction of the x-axis face a same direction in a cross section of the laser beam.

Similarly, a laser beam that is linearly polarized in the direction of the y-axis is provided with a phase rotation angle that is differentiated by π between the regions divided by the related division plane when it passes through the second phase control plate and the linearly polarized components of the electric field vectors running in the direction of y-axis face a same direction in a cross section of the laser beam.

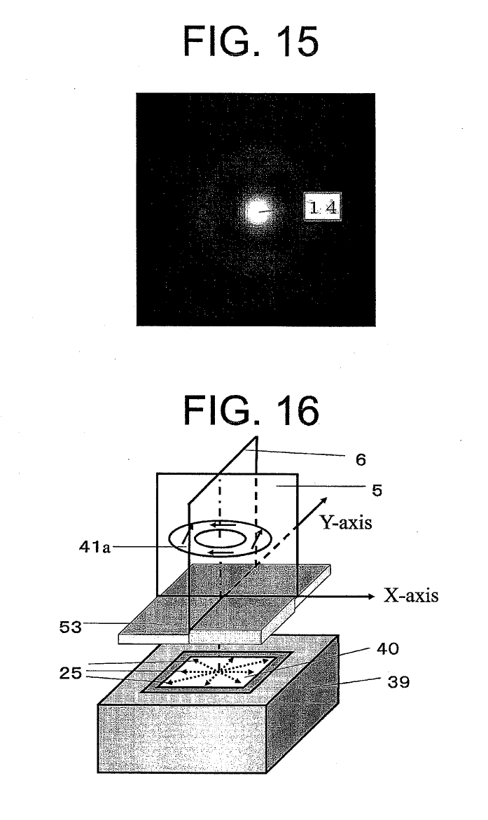

FIG. 15 is a schematic illustration of the focusing pattern of a circumferentially polarized annular laser beam after passing through an optical device as illustrated in FIGS. 13A and 13B. Due to the phase rotation angles given to the laser beam when it passes through the first and second phase control plates, the focusing pattern is turned to show a single-peaked profile.

### Example 3

An exemplar configuration of a surface-emitting laser to which an optical device according to the present invention is applied as a phase control unit on the optical path of an annular laser beam that is emitted from the laser and circumferentially polarized in a direction orthogonal relative to the output plane will be described below by referring to FIG. 16.

In FIG. 16, 25 denotes an intra-planar axis of symmetry and 39 denotes a substrate, while 40 and 41a respectively denote an output plane and a laser beam and 53 denotes a phase control unit.

The surface-emitting laser of this example is configured as a photonic crystal surface-emitting laser device provided with a resonator formed by using photonic crystal having intra-planar axes of symmetry and the photonic crystal surface-emitting laser device is provided on the output plane 40 thereof with a phase control unit 53.

The first division plane 5 and the second division plane 6 illustrated in FIG. 16 are orthogonal relative to the output plane 40 and relative to each other.

Of the circumferentially polarized annular laser beam emitted from the output plane 40 in the direction orthogonal relative to the output plane, the linearly polarized components of the electric field vectors travelling in parallel with the division plane 5 are provided by the phase control unit 53 with a phase rotation angle that is differentiated by π between the regions divided by the first division plane 5.

Similarly, the linearly polarized components of the electric field vectors travelling in parallel with the division plane 6 are provided by the phase control unit 53 with a phase rotation angle that is differentiated by π between the regions divided by the second division plane 6. Such a phase control unit may be formed by using an optical device described in Example 1 or Example 2.

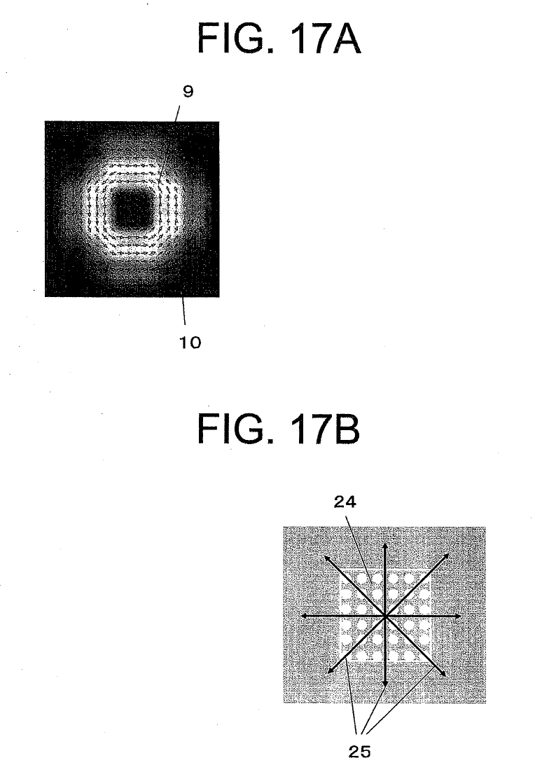

FIG. 17A is a schematic illustration of the results of calculations of the cross-sectional intensity distribution 10 and the electric field vectors 9 (the arrows in FIG. 17A) of a circumferentially polarized annular laser beam emitted from a photonic crystal surface-emitting laser as described in R. Dorn et al., “Sharper Focus for a radially polarized Light Beam”; Physical Review Letters, vol. 91, No. 23, pp. 233901-1 to 233901-4. FIG. 17B is a schematic plan view of the photonic crystal surface-emitting laser having a photonic crystal structure in this example. In FIG. 17B, 24 denotes a photonic crystal resonator.

FIGS. 17A and 17B illustrate that a circumferentially polarized annular laser beam emitted from the photonic crystal surface-emitting laser of this example is influenced by the profile of the photonic crystal resonator 24 so as to show a slightly distorted annular shape, while maintaining its intra-planar symmetry.

Thus, the arrangement of this example can control the phase rotation angle between the regions divided by a division plane and cause the electric field vectors of the divided regions to interfere with each other in same phase at the spot center.

Therefore, the electric field vectors and the cross-sectional intensity distribution of the regions divided by a division plane are preferably symmetric relative to the division plane.

For this reason, at least one of the division planes for dividing the region of the phase control unit 53 illustrated in FIG. 16 is so arranged as to be in parallel with at least one of the intra-planar axes of symmetry 25 of the photonic crystal resonator.

### Example 4

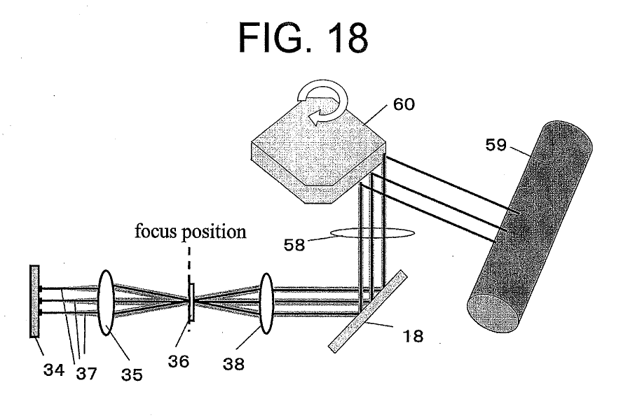

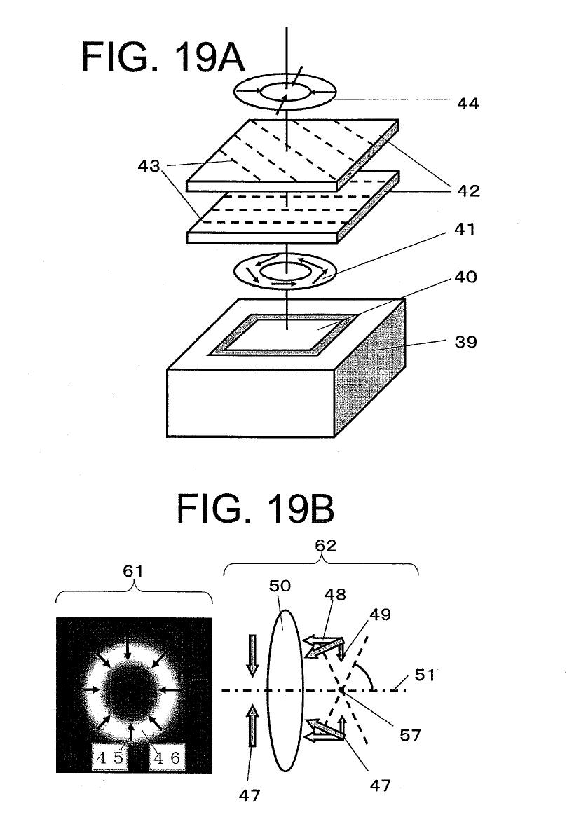

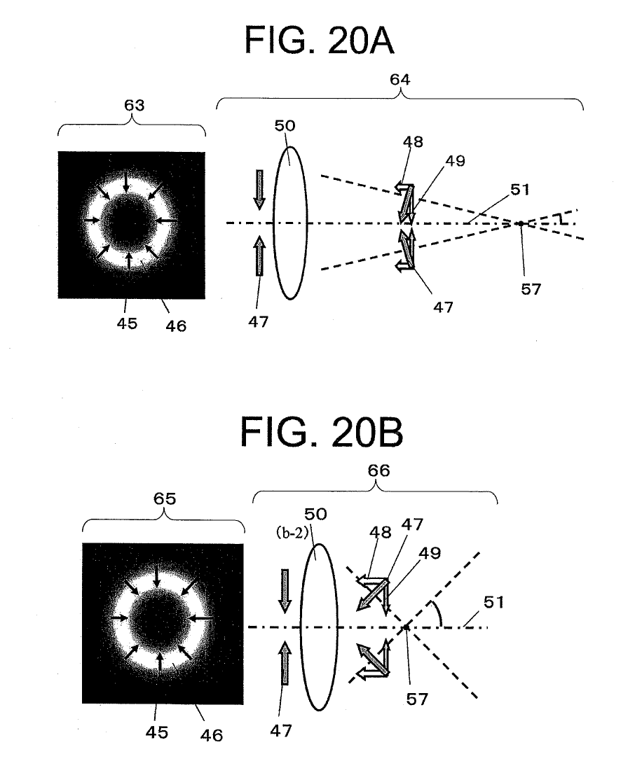

An exemplar configuration of electrophotographic apparatus having a surface-emitting laser array formed by arranging a plurality of surface-emitting lasers according to the present invention as an exposure light source will be described by referring to FIG. 18. In FIG. 18, 18 denotes a mirror and 34, 35 and 36 respectively denote a photonic crystal surface-emitting laser array, a condensing optical system and an optical device, while 37 denotes a circumferentially polarized annular laser beam and 38 denotes a lens. In FIG. 18, 58 denotes a condensing lens and 59 denotes a photosensitive drum, while 60 denotes a polygon mirror.

The electrophotographic apparatus of this example is configured in such a way that an optical device 36 as described in Examples 1 and 2 is arranged on the optical path between the photonic crystal surface-emitting laser array 34 and the condensing lens 58.

Annular laser beams emitted from the photonic crystal surface-emitting laser array 34 and transmitted through the optical device 36 are focused by the condensing lens 58 to form focused spots of light on the photosensitive drum 59 that is composed of a photosensitive member.

As illustrated in FIG. 18, a plurality of circumferentially polarized annular laser beams 37 emitted from the photonic crystal surface-emitting laser array 34 are focused by a common condensing optical system 35 arranged on the optical path extending between the photonic crystal surface-emitting laser array and the condensing lens. These components are so arranged that the centers of the emitted laser beams agree with each other at the focus position of the condensing optical system.

The optical device 36 is arranged at the focus position of the condensing optical system 35. By arranging the optical device at the focus position of the condensing optical system 35, all the laser beams can be provided with the same phase rotation angle by means of the common optical device.

While an instance where a surface-emitting laser according to the present invention is applied to an electrophotographic apparatus in the above description, the present invention is by no means limited thereto. For example, a surface-emitting laser according to the present invention can find suitably applications in exposure light source of optical recording apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-189178, filed Aug. 26, 2010, which is hereby incorporated by reference herein in its entirety.

What is claimed is:

1. An optical device comprising a region divided into a first division plane running in parallel with a direction of an incident vector of a laser beam entering an incidence place for the laser beam and a second division plane running in parallel with the direction of the incident vector and orthogonally relative to the first division plane, wherein:
provides the laser beam with phase rotation angles differentiated by π between the regions divided by the first division plane when the laser beam travels in the direction of the incident vector and is linearly polarized in a direction parallel to the first division plane; and
also provides the laser beam with phase rotation angles differentiated by π between the regions divided by the second division plane when the laser beam travels in the direction of the incident vector and is linearly polarized in a direction parallel to the second division plane.

2. The optical device according to claim 1, wherein:
the regions divided by the first division plane and the second division plane are divided into first through fourth regions by the first and second division planes;
½ wave plates being arranged respectively in the second region and in the fourth region, which are one of the two pairs of diagonally disposed regions;
optical plates being arranged respectively in the first region and in the third region, which are the other one of the two pairs of diagonally disposed regions;
the ½ wave plate in the second region being so arranged as to make a phase advancing axis and a phase lagging axis of the ½ wave plate respectively run in parallel with the first division plane and the second division plane;
the ½ wave plate in the fourth region being so arranged as to make the phase advancing axis and the phase lagging axis of the ½ wave plate respectively run in parallel with the second division plane and the first division plane;
the optical plate arranged in the first region providing the laser beam linearly polarized in the direction parallel to the first division plane with a phase rotation angle equal to the phase rotation angle of the laser beam after passing through the ½ wave plate arranged in the second region; and
the optical plate arranged in the third region providing the laser beam linearly polarized in the direction parallel to the first division plane with a phase rotation angle equal to the phase rotation angle of the laser beam after passing through the ½ wave plate arranged in the fourth region.

3. The optical device according to claim 2, wherein the device further comprises a first phase control plate and a second phase control plate orthogonal relative to the direction of the incident vector of the laser beam;
the first phase control plate having a ½ wave plate and an optical plate respectively in the regions divided by the first division plane;
the ½ wave plate being so arranged as to make a phase advancing axis and a phase lagging axis thereof respectively run in parallel with the first division plane and the second division plane;
the optical plate providing the laser beam linearly polarized in the direction orthogonal relative to the first division plane with a phase rotation angle equal to the phase rotation angle of the laser beam after passing through the ½ wave plate;
the second phase control plate having a ½ wave plate and an optical plate respectively in the regions divided by the second division plane;
the ½ wave plate being so arranged as to make a phase advancing axis and a phase lagging axis thereof respectively run in parallel with the second division plane and the first division plane; and
the optical plate providing the laser beam linearly polarized in the direction orthogonal relative to the second division plane with a phase rotation angle equal to the phase rotation angle of the laser beam after passing through the ½ wave plate.

4. The optical device according to claim 1, wherein a surface of a wave plate or a optical plate is coated with anti-reflection film, reflection film or absorption film that equalizes a transmittance of the regions divided by the first division plane and the second division plane.

5. A surface-emitting laser for emitting a circumferentially polarized annular laser beam in a direction orthogonal relative to an output plane thereof, the laser comprising a phase control unit on an optical path of the emitted laser beam;
the phase control unit being formed by the optical device according to claim 1.

6. The surface-emitting laser according to claim 5, further comprising a resonator formed by means of photonic crystal having intra-planar axes of symmetry, at least one of the first division plane and the second division plane is so arranged as to be parallel with at least one of the intra-plane axes of symmetry of the resonator.

7. An electrophotographic apparatus comprising a surface-emitting laser array as an exposure light source, formed by arranging a plurality of surface-emitting lasers having a resonator formed by means of photonic crystal,
the electrophotographic apparatus including a condensing lens for focusing a laser beams emitted from the surface-emitting laser array on a surface of a photosensitive member,
an optical system for making centers of the laser beams emitted from the surface-emitting laser array agree with each other being arranged on a optical path extending between the surface-emitting laser array and the condensing lens, and
the electrophotographic apparatus including the optical device according to claim 1 arranged at the position where the centers of the laser beams are made to agree with each other by the optical system.
